(19) United States
(12) Patent Application Publication
(10) Pub. No.: US 2026/0254757 A1
(43) Pub. Date: Aug. 27, 2026

(54) SYSTEMS AND METHODS FOR NETWORK CONGESTION MANAGEMENT

(71) Applicant: T-Mobile Innovations LLC, Overland Park, KS (US)

(72) Inventor: Timur KOCHIEV, Irvine, CA (US)

(21) Appl. No.: 19/062,620

(22) Filed: Feb. 25, 2025

(51) Int. Cl. H04L 47/12; H04W 48/18

(52) U.S. Cl. CPC H04L 47/12; H04W 48/18

(57) ABSTRACT

Systems, methods and devices are provided for network congestion management. The method includes receiving, by a wireless network communicatively connected to a non-L4S capable wireless device, a congestion signal from a L4S capable wireless device and, in response to receiving a congestion signal from the L4S capable wireless device, adjusting, by the wireless network, session configurations for the non-L4S capable wireless device.

### TECHNICAL BACKGROUND

5G networks are capable of assigning a network slice to a wireless device, or user equipment, based on requirements of the network. Network slicing allows a single network to be divided into multiple slices. Each slice can be configured and used in its own way. In instances, a network slice may be established and configured for limited bandwidth. For example, network slices may be configured for different Quality of Service (QoS) levels such as a network slice for lower bandwidth connection. Often a network may include devices that are low latency, low loss, scalable throughput (L4S) capable and devices that are not capable of L4S, which may reduce congestion control of the network due to the non-L4S devices connected to the network.

### OVERVIEW

Exemplary embodiments described herein include systems, methods, and processing nodes for network congestion management. An exemplary method includes receiving, by a wireless network communicatively connected to a non-L4S capable wireless device, a congestion signal from a L4S capable wireless device and, in response to receiving a congestion signal from the L4S capable wireless device, adjusting, by the wireless network, session configurations for the non-L4S capable wireless device.

Further exemplary embodiments include a system for network congestion management. The system includes a non-L4S capable wireless device configured to connect to a network slice and computing device communicatively connected to a wireless network, wherein the computing device includes at least one processor configured to receive a congestion signal from a L4S capable wireless device and, in response to receiving a congestion signal from the L4S capable wireless device, adjust session configurations for the non-L4S capable wireless device.

In yet a further exemplary embodiment, a non-transitory computer readable medium is provided. The non-transitory computer-readable medium stores instructions, when executed by a processor, configuring the processor to receive a congestion signal from an L4S capable wireless device and, in response to receiving the congestion signal form the L4S capable wireless device, adjust session configurations for the non-L4S capable wireless device.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates a block diagram illustrating an exemplary system for network congestion management;

FIG. 3 illustrates an exemplary process flow for network congestion management;

FIG. 4 illustrates an example of a computing device in accordance with aspects of this disclosure; and

FIG. 5 illustrates an exemplary processing node in accordance with various aspects of the present disclosure.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a core network, such as a new radio 5G (NR 5G), provides congestion management based on congestion signals from L4S capable devices. For a NR 5G network, the core network provides network slices that can be used to provide different levels of Quality of Service (QoS) depending on the need of the network. For example, a network slice may be created with a reduced bandwidth or limited rate to reduce the traffic generated by a connected device.

For L4S capable devices, the L4S architecture enables the management of traffic congestion with no, or minimum, packet losses. However, managing traffic congestion for user devices not capable of L4S often involves dropping packets, thus degrading the user experience. To alleviate the traffic congestion for non-L4S devices without the packet losses, the NR 5G may be capable of modifying the session configurations, by limiting performance of the connection, for the non-L4S capable device based on congestions signals received from L4S capable devices.

There is a wide range of applications that rely on real-time communication, interactive experiences, or high-performance data transmission such as online and cloud gaming, video conferencing, AR/VR, live streaming, and others. All these applications can potentially benefit from the use of L4S technology.

In short, L4S utilizes ECN (Explicit Congestion Notification) embedded within the IP header to signal queue congestion within RAN to the application. This congestion information is handled by scalable congestion control algorithms at both the sender and receiver ends and communicated to the application server, prompting adjustments to the application's bitrate. As a result, it aligns with the capacity of the established communication link.

As of now, widespread implementation of L4S is not common and only some models support it. Thus, the devices that do not support L4S will likely have degraded user experience during congestion, such as packet losses.

Devices that do not support L4S could benefit from receiving congestion information from nearby devices that do support L4S. This approach would entail utilizing a cooperative network environment where devices share network status and congestion information to improve user experience.

Upon detecting congestion, the network could dynamically adjust traffic management by placing non-L4S-capable devices on a slice with limited bandwidth or applying rate-limiting policies to those flows. This would prevent non-L4S devices from exacerbating the congestion in L4S-supported traffic paths.

Since L4S aims to provide ultra-low latency, the network can prioritize L4S traffic while reducing the bitrate for non-L4S devices to ensure that latency-sensitive applications aren't impacted. The reduced-bitrate slice could serve as a fallback, still providing connectivity but with limited performance to help balance the load during congestion.

Automated policies could dynamically allocate devices to slices based on real-time congestion feedback from L4S devices, thus enhancing the efficiency of resource usage across the network. AI/ML algorithms may be used to leverage historical congestion data from L4S-enabled devices to anticipate when and where congestion may likely occur, allowing the network to preemptively manage non-L4S traffic by moving it to a reduced bitrate slice.

Historical congestion data from L4S devices, including metrics like packet loss, delay, and throughput, can be aggregated along with network conditions (e.g., time of day, traffic loads). Key features might include frequency and duration of congestion events, traffic volume during peak hours, latency or packet loss trends by location or slice, and the like.

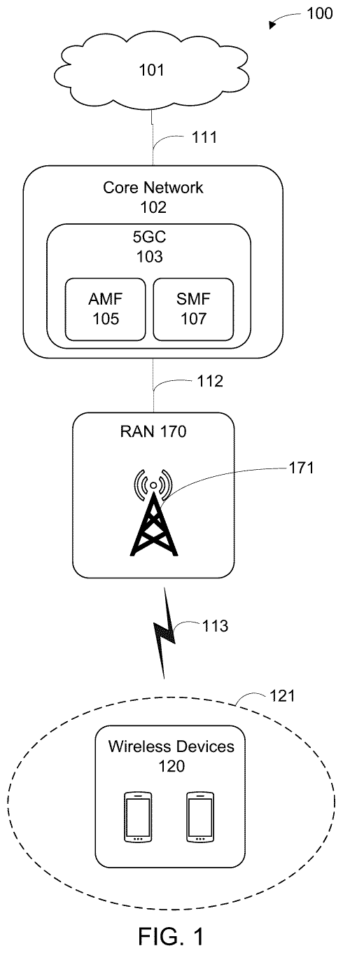

These and other examples will be described in greater detail below in relation to FIGS. 1-5.

FIG. 1 depicts an exemplary system 100 for network congestion management. System 100 includes a communication network 101, a core network 102, a radio access network (RAN) 170 and wireless devices 120.

Core network 102 is connected to communication network 101 over communication link 111. Core network 102 includes a 5G core (5GC) 103. 5GC 103 as used herein are core network components used for managing data for 5G networks. In embodiments, 5GC 103 may include an evolved packet core (EPC), used for managing data for LTE, 4G and/or other networks. In instances, the core network 102 may have other types of core architecture (e.g., 6G core architecture) that at least perform some similar functions as and/or share at least some components with the 5GC 103 with respect to congestion management and network slicing for wireless devices.

It should be noted that core network 102 may include other components used for managing data for networks not described herein, such as a satellite core network.

In embodiments, 5GC 103 includes an access and mobility function (AMF) 105. AMF 105 receives connection and session related information from the wireless devices 120 and is responsible for handling connection and mobility management tasks on a 5G network. In an embodiment, AMF 105 may be used for determining connection configuration for a device, such as wireless device 120. For example, AMF 105 may communicate with a network slice selection function (NSSF) to determine a slice configuration based on changes in the quality of service (QoS) policies. In instances, AMF 105 may be used for assigning a network slice for a device, such as wireless device 120. For example, if QoS policies change for the connection, such as detection of congestion in the network, AMF 105 may assign the device to a network slice with reduced-bitrate configurations, such as limited bandwidth or rate limited polices applied.

In embodiments, 5GC 103 includes a session management function (SMF) 107. The SMF 107 receives slice configuration for a network slice serving a device, such as wireless device 120, and is responsible for adjusting session configurations for the network slice. In embodiments, SMF 107 may adjust a session based on receiving a new slice configuration from AMF 105. For example, SMF 107 may receive slice configuration from AMF 105, such as based on detection of congestion, and be used to adjust session configuration of the connected wireless device 120 based on the slice configuration.

The RAN 170 includes access nodes 171. In embodiments, the access nodes 171 include an evolved Node B (eNodeB) and a next generation Node B (gNodeB). As used herein, an eNode B is a base station in LTE/4G networks used for connecting a user device, such as wireless device 120, to core network 102. A gNodeB, as used herein, is a base station in 5G networks and/or other networks used for connecting a user device to core network 102. The gNodeB may include, for example, centralized units (CUs) and distributed units (DUs). In embodiments, the access nodes 171 are equipped with L4S-aware scheduling and dual-queue active queue management (DualQ AQM). For example, access nodes 171 may be configured to mark packets when congestion is detected in the network, such as through explicit congestion notification (ECN) marks.

RAN 170 is connected to core network 102 over communication link 112. RAN 170 may include other devices and additional nodes not described herein. For example, RAN 170 may include devices used for forwarding media files over IP from wireless devices 120 to core network 102.

System 100 also includes wireless devices 120. In embodiments, system 100 may include two or more wireless devices. Wireless devices 120 are configured to operate in one or more coverage areas 121. Wireless devices 120 may include an end-user wireless device. Wireless devices 120 may include any device configured to send and receive data. In instances, wireless devices 120 may include L4S capable and non-L4S capable wireless devices. In embodiments, wireless device 120 communicates with RAN 170 over communication link 113. Examples of communication link 113 may include 5G network, 4G LTE, and the like.

In embodiments, wireless devices 120 include at least one L4S capable wireless device 123 and at least one non-L4S capable wireless device 124. An L4S capable wireless device 123 includes any device configured to support L4S traffic handling. In instances, L4S capable wireless device 123 is configured to transmit congestion signals to 5GC 102. For example,

Communication network 101 may be wired and/or wireless communication network. In embodiments, communication network 101 may include processing nodes, routers, gateways, physical and/or wireless data links for carrying data among various network elements, including combinations thereof. In embodiments, communication network 101 may include a local area network, a wide area network, an inter-network, such as the internet, and the like. Communication network 101 may be capable of carrying data, such as, for example, to support multimedia files, and data communications by wireless devices 120. Wireless network protocols can include multimedia broadcast multicast service (MBMS), code division multiple access (CDMA) 1xRTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE), 6G and/or non-terrestrial networks. Wired network protocols that may be utilized by communication network 101 comprise Ethernet, Fast Ethernet, Gigabit Ethernet, Local Talk (such as Carrier Sense Multiple Access with Collision Avoidance), Token Ring, Fiber Distributed Data Interface (FDDI), Asynchronous Transfer Mode (ATM), and/or so forth. Communication network 101 may also include additional base stations, controller nodes, telephony switches, internet routers, network gateways, computer systems, communication links, or some other type of communication equipment, and combinations thereof.

The core network 102 includes core network functions and elements. The core network 102 may be structured using a service-based architecture (SBA). The network functions and elements may be separated into user plane functions and control plane functions. In an SBA architecture, service-based interfaces may be utilized between control-plane functions, while user-plane functions connect over point-to-point link. The user plane function (UPF) accesses a data network, such as network 101, and performs operations such as packet routing and forwarding, packet inspection, policy enforcement for the user plane, quality of service (QoS) handling, etc. The UPF may detect congestion of a network, such as form a L4S capable wireless device 120. In instances, the UPF may apply dual queue active queue management (DualQ AQM) based on the congestion detection. The control plane functions may include, for example, a network slice selection function (NSSF), a network exposure function (NEF), a network repository function (NRF), a policy control function (PCF), a unified data management (UDM) function, an application function (AF), an AMF, such as AMF 105, an authentication server function (AUSF), and a session management function (SMF). Additional or fewer control plane functions may also be included. The AMF receives connection and session related information from the wireless devices 120 and is responsible for handling connection and mobility management tasks. The SMF is primarily responsible for creating, updating, and removing sessions and managing session context. The UDM function provides services to other core functions, such as the AMF 105, SMF 107, and NEF. The UDM may function as a stateful message store, holding information in local memory. The NSSF can be used by AMF 105 to assist with the selection of network slice instances that will serve a particular device. Further, the NEF provides a mechanism for securely exposing services and features of the core network.

In instances, the UDM may include a mapping of DNNs to network slice selection assistance information (nSSAI) associated with a wireless device 120. nSSAI includes a set of single nSSAI(S-nSSAI). Each S-nSSAI may include a slice/service type and a slice differentiator (SD). For example, AMF 105 may query UDM for S-nSSAIs associated with a DNN. In an example, AMF 105 may use NSSF for selecting a S-nSSAI based on additional requirements, such as regional availability. In some embodiments, UDM may detect a subscription expiration for a slice, such a validity period based slice, and notify AMF 105 of the expiration. Once notified, AMF 105 updates nSSAI by removing expired S-nSSAIs.

Although one core network 102 is shown, multiple core networks 102 may be utilized. Alternatively, the single core network 102 may include a distributed, cloud-native, converged core gateway. Thus, the converged core gateway could connect an EPC to 5GC 103 network.

Communication links 111 and 112 can use various communication media, such as air, space, metal, optical fiber, or some other signal propagation path, including combinations thereof. Communication links 111 and 112 can be wired or wireless and use various communication protocols such as Internet, Internet protocol (IP), local-area network (LAN), S1, optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, 6G or combinations thereof. Other wireless protocols can also be used. Communication links 111 and 112 can be direct links or might include various equipment, intermediate components, systems, and networks, such as a cell site router, etc. Communication links 111 and 112 may comprise many different signals sharing the same link.

In embodiments, RAN 170 may include various access network systems and devices such as access nodes 171. The RAN 170 is disposed between the core network 102 and the end-user wireless device 120. Components of the RAN 170 may communicate directly with the core network 102 and others may communicate directly with the end user wireless device 120. The RAN 170 may provide services from the core network 102 to the end-user wireless device 120. It is understood that the disclosed technology may also be applied to communication between an end-user wireless device and other network resources, such as relay nodes, controller nodes, antennas, etc. Further, multiple access nodes may be utilized. For example, some wireless devices may communicate with an eNodeB and others may communicate with a gNodeB.

In additional embodiments, access nodes 171 may comprise two co-located cells, or antenna/transceiver combinations that are mounted on the same structure. Alternatively, access nodes 171 may comprise a short range, low power, small-cell access node such as a microcell access node, a picocell access node, a femtocell access node, and/or a home eNodeB device. As will be further described below, functionality for network node switching may be included within the access nodes 171. Access nodes 171 can be configured to deploy one or more different carriers, utilizing one or more RATs. For example, a gNodeB may support NR. It would be evident to one of ordinary skill in the art, in light of this disclosure, the many other combinations of access nodes and carriers that could be deployed.

The access node 171 may include a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

The wireless devices 120 may include any wireless device included in a wireless network. For example, the term “wireless device” may include a relay node, which may communicate with an access node. The term “wireless device” may also include an end-user wireless device, which may communicate with access nodes 171 through the relay node. The term “wireless device” may further include an end-user wireless device that communicates with the access node 171 directly without being relayed by a relay node. In instances, wireless devices 120 may include a L4S capable device. Wireless devices 120 may include wireless devices without L4S capability.

Wireless devices 120 may be any device, system, combination of devices, or other such communication platform capable of communicating wirelessly with access nodes 171 using one or more frequency bands and wireless carriers deployed therefrom. Each of wireless devices 120, may be, for example, a mobile phone, a wireless phone, a wireless modem, a personal digital assistant (PDA), a voice over internet protocol (VoIP) phone, a voice over packet (VOP) phone, or a soft phone, an internet of things (IoT) device, as well as other types of devices or systems that can send and receive audio or data. The wireless device 120 may be or include high power wireless devices or standard power wireless devices. Other types of communication platforms are possible.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork, such as the internet. System 100 may be capable of communicating signals and carrying data, for example, to support voice, push-to-talk, broadcast video, and data communications by end-user wireless devices 120. System 100 may include additional base stations, controller nodes, telephony switches, internet routers, network gateways, computer systems, communication links, or other type of communication equipment, and combinations thereof.

Other network elements may be present in system 100 to facilitate communication but are omitted for clarity, such as base stations, base station controllers, mobile switching centers, and dispatch application processors. Furthermore, other network elements that are omitted for clarity may be present to facilitate communication, such as additional processing nodes, routers, gateways, and physical and/or wireless data links for carrying data among the various network elements, e.g. between the RAN 170 and the core network 102.

The methods, systems, devices, networks, access nodes, and equipment described herein may be implemented with, contain, or be executed by one or more computer systems and/or processing nodes. The methods described above may also be stored on a non-transitory computer readable medium. Many of the elements of system 100 may be, comprise, or include computers systems and/or processing nodes, including access nodes, controller nodes, and gateway nodes described herein.

The operations for network congestion management may be implemented as computer-readable instructions or methods, and processing nodes on the network and/or computing device, such as end user wireless device, for executing the instructions or methods. The processing node may include a processor included in the access node or a processor included in any controller node in the wireless network that is coupled to the access node. The computing device may include at least a processor and a memory with instructions configuring the processor to execute instructions.

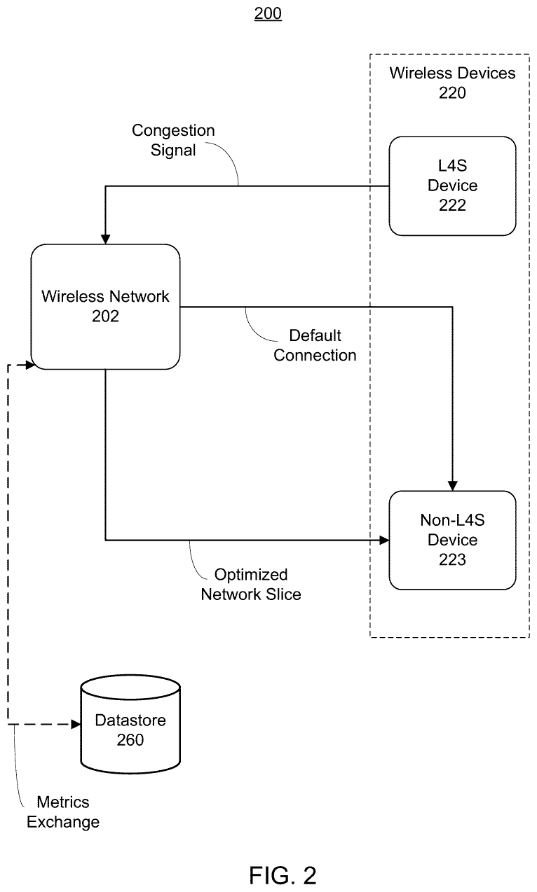

Now referring to FIG. 2, an exemplary system 200 for network congestion management is presented. System 200 includes wireless network 202. Wireless network 202 may include a RAN, core network and/or a communication network, which may be the same as, respectively, RAN 170, core network 102 and communication network 101. Wireless network 202 includes services and components used by a wireless network for L4S traffic handling and network slice management. In an example, wireless network 202 is configured to utilize scalable congestion control algorithms, such as TCP Prague.

System 200 includes wireless devices 220. Wireless device 220 may be the same as wireless device 120. Wireless devices 220 include L4S device 222. In embodiments, wireless devices 220 may include a plurality of L4S devices 222. L4S device 222 may include any L4S capable device. For example, L4S device 222 may be any device capable of transmitting ECN-capable packets and receiving ECN feedback. In instances, L4S device 222 may use dual queue active management (DualQ AQM) for handling L4S and non-L4S traffic. In embodiments, L4S device 222 is configured to transmit congestion signals to wireless network 202. For example, a congestion signal may include an ECN signal, such as ECN-capable packets. It should be noted that wireless network 202 is described as receiving the congestion signal from a single L4S device 222 for ease of description, and as such, the congestion signal may include signals received from a plurality of L4S devices 222.

In embodiments, wireless network 202 includes non-L4S device 223. Non-L4S device 223 may include any device not capable of supporting L4S. In instances, wireless network 202 may include a plurality of non-L4S devices 223. In embodiments, non-L4S device 223 is connected to wireless network through a default connection. In some embodiments, the default connection may include a connection using a network slice.

Wireless network 202, based on detecting a congestion signal from L4S device 222, assigns an optimized network slice for the non-L4S device 223. The optimized network slice may include session configuration with limited bandwidth or with rate-limiting policies applied to the session. In instances, the optimized network slice may include session configurations with further changes to QoS policies, such as lowering the scheduling priority of non-L4S flows, setting higher permissible latency and jitter threshold for non-L4S sessions, and the like. The application of the optimized network slice enables the connection for the non-L4S device 223 to continue uninterrupted, although with limited performance.

In embodiments, wireless network 202 may exchange congestion metrics with a datastore 260. Datastore 260 may include any data storing medium, such as a database. In instances, data related to detected congestion signals may be stored in datastore 260 to be used as training data for machine learning processes. For example, data related to marked packets (i.e. congestion signal) may be correlated to timestamps for the signals. In embodiments, this training data may be used for training machine learning models, which may be used for predicting congestion in the network prior to detection of congestion signal. For example, if network congestion is predicted to increase during a specific time and day of the week, non-L4S devices 223 may be preemptively assigned to optimized network slices to prevent the predicted congestion. In an example, training data may include data related to frequency and duration of congestion events, such as congestion signals correlated to the length of time of detection of the signals. Training data may include network traffic volume during detection of signals. In an example, training data may also include packet loss for non-L4S device 223 during times of congestion.

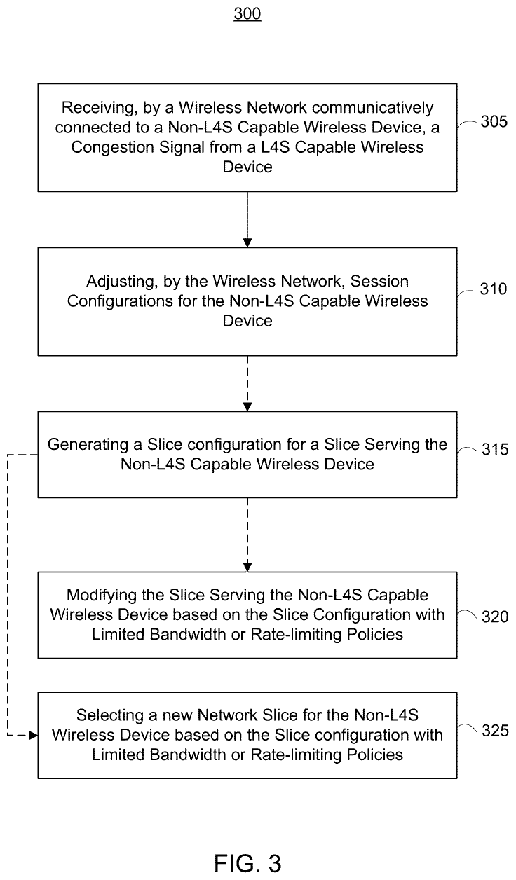

With reference to FIG. 3, a flow diagram of method 300 for network congestion management is presented. Method 300 includes, at step 305, receiving, by a wireless network communicatively connected to a non-L4S capable wireless device, a congestion signal from a L4S capable wireless device. In embodiments, the congestion signal may include an ECN. The L4S capable wireless device and the non-L4S capable wireless device may include, respectively, L4S device 222 and non-L4S device 223 described in reference to FIG. 2.

At step 310, method 300 includes adjusting, by the wireless network, session configurations for the non-L4S capable wireless device in response to receiving the congestion signal from the L4S capable wireless device. In embodiments, adjusting session configurations may include assigning a network slice for the non-L4S capable wireless device. The network slice may be the same as the optimized network slice described in reference to FIG. 2.

In embodiments, method 300 may include, at step 315, generating a slice configuration for a network slice serving the non-L4S capable wireless device. In some embodiments, method 300, at step 320, may include modifying the slice service the non-L4S capable wireless device based on the slice configuration with limited bandwidth or rate-limiting policies. In embodiments, method 300 may include, at step 325, selecting a new network slice for the non-L4S wireless device based on the slice configuration with limited or rate-limiting policies.

In embodiments, method 300 may include determining the session configuration used for adjusting the session configurations for the non-L4S capable wireless device using a machine learning model. In instances, the machine learning model may be trained using training data that includes historical congestion data. For example, training data may include congestion signals correlated to timestamps. In an example, training data may include congestion signals correlated to non-L4S device capabilities.

In some embodiments, methods 300 may include additional steps or operations. Furthermore, the methods may include steps shown in each of the other methods. As one of ordinary skill in the art would understand, method 300 may be integrated in any useful manner and the steps may be performed in any useful sequence.

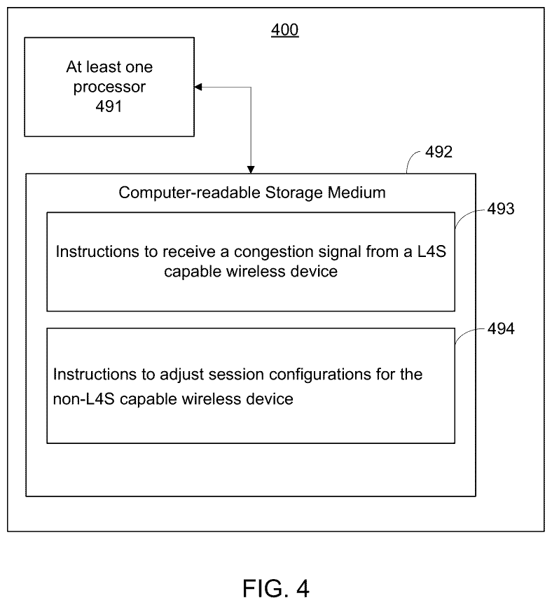

Now referring to FIG. 4, an example computing device 400 is presented. In embodiments, computing device 400 may include a node device, such as devices operating within communication network described in reference to FIG. 1. In this example, computing device 400 includes at least one processor 491 communicably coupled to a computer-readable storage medium 492. The at least one processor 491 may include a microprocessor, a microcontroller, one or more central processing unit (CPU) cores, an application-specific integrated circuit (ASIC), one or more graphical processing unit (GPU) cores, a field programmable gate array (FPGA), and/or any other hardware device suitable for retrieval and execution of instructions from computer-readable storage medium 492. In instances, at least one processor 491 may include electronic circuitry for performing instructions described in this disclosure.

In instances, computer-readable storage medium 492 may be any medium suitable for storing executable instructions. In examples, without limitation, computer-readable storage medium 492 may include read-only memory (ROM), random-access memory (RAM), erasable electrically programmable ROM (EEPROM), Solid State Drive (SSD), optical disc, and the like. Computer-readable medium storage 492 may be disposed within computing device 400. In embodiments, computer-readable storage medium 492 may be external, and communicably connected, to computing device 300. The instruction stored on computer-readable storage medium may be used to implement method steps described in reference to FIG. 3.

In this example, computer-readable storage medium 492 is encoded with a set of instructions 493 and 494. In embodiments, executable instructions included in each block may be included in different blocks shown and blocks not shown.

Instruction 493, when executed by at least one processor 491, configures the at least one processor 491 to receive a congestion signal from a L4S capable wireless device.

Instruction 494, when executed by at least one processor 491, configures the at least one processor 491 to adjust session configurations for the non-L4S capable wireless device. In embodiments, adjusting session configurations comprises assigning a network slice with limited bandwidth or rate-limiting policies to the non-L4S capable wireless device.

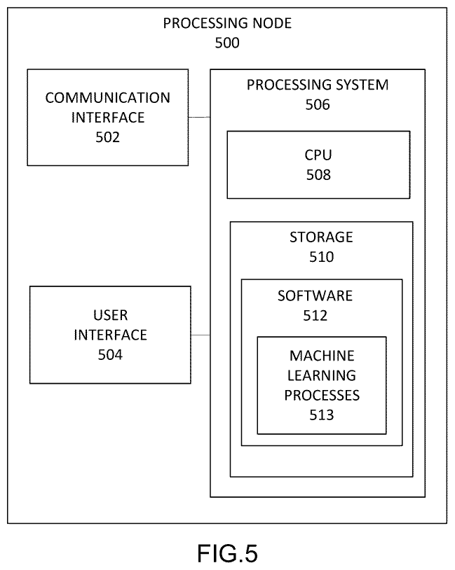

In embodiments, computer-readable storage medium 392 may include instructions configuring the at least one processor 391 to determine the session configuration used for adjusting the session configurations for the wireless device as a function of a machine leaning model. The machine learning model is described in further detail in reference to FIG. 5.

Now referring to FIG. 5, an example processing node 500, which may be configured to perform the methods and operations disclosed herein for network congestion management. The processing node 500 includes a communication interface 502, user interface 504, and processing system 506 in communication with communication interface 502 and user interface 504. Communication interface 502 may include hardware components, such as network communication ports, devices, routers, wires, antenna, transceivers, etc. User interface 504 may include hardware components, such as touch screens, buttons, displays, speakers, etc.

Processing system 506 includes a central processing unit (CPU) or processor 508 and storage 510. Storage 510 may include a disk drive, flash drive, memory circuitry, or other memory device including, for example, a buffer. Storage 510 can store software 512 which is used in the operation of the processing node 500. Software 512 may include computer programs, firmware, or some other form of machine-readable instructions, including an operating system, utilities, drivers, network interfaces, applications, or some other type of software. Processing system 506 may include a processor 508 and other circuitry to retrieve and execute software 512 from storage 510, which may be internal or external to the processing system 506. Processing node 500 may further include other components such as a power management unit, a control interface unit, etc., which are omitted for clarity. Communication interface 502 permits processing node 500 to communicate with other network elements. User interface 504 permits the configuration and control of the operation of processing node 500. Processing node 500 may be included in various elements of the wireless network including an access node, proxy call session control function (P-CSCF), gateway mobile location center (GMLC), radio resource control (RRC), inter-cell interference coordination (ICIC), medium access control (MAC), session border controller (SBC), and the like. In this example, software 512 may include the instructions described in reference to FIG. 4.

In embodiments, software 512 includes machine learning processes 513. In embodiments, processing system 506 may use machine learning processes 513 to perform determinations, classifications and or analysis steps. In embodiments, machine learning processes 513 may be used to generate a machine learning model. For example, processing node 500 may be configured to determine session configuration used for adjusting the session configurations for the non-L4S capable wireless device, such as non-L4S device 223 described in reference to FIG. 2, using machine learning processes 513.

In instances, processing system 506 may use machine learning processes 513 to generate training data. In embodiments, processing system 506 may use the training data to train a machine learning model. For example, machine learning processes 513 may model relationships between two or more categories of data elements using the training data. In embodiments, training data may include historical congestion data from L4S capable devices. In some examples, training data may include one or more elements not categorized. In embodiments, machine learning processes 513 may include a neural network. As used herein, a neural network is a network of data structures, or nodes, that contains one or more inputs, one or more outputs and a function for determining outputs based on the inputs, where the network includes an input layer, an output layer and oner or more intermediate layers. In instances, neural network may have a recurrent architecture, such as a recurrent neural network (RNN). For example, RNN may be used for generating time series predictions. In embodiments, the neural network may have a memory cell based architecture, such as a long short-term memory (LSTM) network. For example, LSTM may be used for generating time series forecasting based on long term dependencies.

Although the descriptions provided herein may be in the context of certain radio access technologies, networks, and network topologies, such as 5G/NR mobile communications, the proposed concepts, schemes, and any variations thereof may be implemented in, for and by other types of radio access technologies, networks, and network topologies. Such radio access technologies, networks, and network topologies may include, for example and without limitation, Long-Term Evolution (LTE), Internet-of-Things (IoT), Narrow Band Internet of Things (NB-IoT), vehicle-to-everything (V2X), fixed wireless internet, and non-terrestrial network (NTN) communications. Thus, the scope of the disclosure is not limited to the examples described herein.

The exemplary systems and methods described herein may be performed under the control of a processing system executing computer-readable codes embodied on a computer-readable recording medium or communication signals transmitted through a transitory medium. The computer-readable recording medium may be any data storage device that can store data readable by a processing system, and may include both volatile and nonvolatile media, removable and non-removable media, and media readable by a database, a computer, and various other network devices. Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium may also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not all be within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method, the method comprising:
receiving, by a wireless network communicatively connected to a non-L4S capable wireless device, a congestion signal from a L4S capable wireless device; and
in response to receiving the congestion signal from the L4S capable wireless device, adjusting, by the wireless network, session configurations for the non-L4S capable wireless device.

2. The method of claim 1, wherein adjusting session configurations comprises assigning a network slice to the non-L4S capable wireless device.

3. The method of claim 1, further comprising generating a slice configuration for a slice serving the non-L4S capable wireless device.

4. The method of claim 3, wherein adjusting session configurations comprises modifying the slice serving the non-L4S capable wireless device based on the slice configuration with limited bandwidth or rate-limiting policies.

5. The method of claim 3, wherein adjusting session configurations comprises selecting a new network slice for the non-L4S capable wireless device based on the slice configuration with limited bandwidth or rate-limiting policies.

6. The method of claim 1, wherein the congestion signal comprises an explicit congestion notification (ECN).

7. The method of claim 1, wherein a machine learning model determines session configurations used for adjusting the session configurations for the non-L4S capable wireless device.

8. The method of claim 7, wherein the machine learning model is trained using training data comprising historical congestion data.

9. A system, the system comprising:
a non-L4S capable wireless device configured to connect to a network slice; and
a wireless network comprising at least one computing device communicatively connected to the non-L4S capable wireless device, wherein the at least one computing device is configured to:
receive a congestion signal from a L4S capable wireless device; and
in response to receiving the congestion signal from the L4S capable wireless device, adjust session configurations for the non-L4S capable wireless device.

10. The system of claim 9, wherein adjusting session configurations comprises assigning a network slice to the non-L4S capable wireless device.

11. The system of claim 9, wherein the at least one computing device is further configured to generate a slice configuration with limited bandwidth or rate-limiting policies for a slice serving the non-L4S capable wireless device.

12. The system of claim 11, wherein adjusting session configurations comprises modifying the slice serving the non-L4S capable wireless device based on the slice configuration with limited bandwidth or rate-limiting policies.

13. The system of claim 11, wherein adjusting session configurations comprises selecting a new network slice for the non-L4S wireless device based on the slice configuration with limited bandwidth or rate-limiting policies.

14. The system of claim 9, wherein the congestion signal comprises an explicit congestion notification (ECN).

15. The system of claim 9, wherein the at least one computing device is further configured to determine the session configuration used for adjusting the session configurations for the non-L4S capable wireless device as a function of a machine learning model.

16. The system of claim 15, wherein the machine learning model is trained using training data comprising historical congestion data.

17. A non-transitory computer-readable medium storing instructions, when executed by at least one processor, configuring the at least one processor to:
receive a congestion signal from an L4S capable wireless device; and
in response to receiving the congestion signal from the L4S capable wireless device, adjust session configurations for a non-L4S capable wireless device.

18. The non-transitory computer-readable medium storing instructions of claim 17, wherein adjusting session configurations comprises assigning a network slice with limited bandwidth or rate-limiting policies to the non-L4S capable wireless device.

19. The non-transitory computer-readable medium storing instructions of claim 17, wherein the congestion signal comprises an explicit congestion notification (ECN).

20. The non-transitory computer-readable medium storing instructions of claim 17, wherein the at least one processor is further configured to determine the session configuration used for adjusting the session configurations for the wireless device as a function of a machine learning model.
